(19) United States
(12) Patent Application Publication
(10) Pub. No.: US 2026/0216623 A1
(43) Pub. Date: Jul. 30, 2026

(54) WATER FILTRATION DEVICE

(71) Applicant: LG ELECTRONICS INC., Seoul (KR)

(72) Inventors: Suhye WOO, Seoul (KR); Jongpil KIM, Seoul (KR); Sangduck LEE, Seoul (KR); Yuseung CHOI, Seoul (KR); Jinhyun LEE, Seoul (KR)

(21) Appl. No.: 19/142,298

(22) PCT Filed: Nov. 3, 2023
(86) PCT No.: PCT/KR2023/017486

§ 371 Date: Jun. 23, 2025

(30) Foreign Application Priority Data
Dec. 22, 2022 (KR) 10-2022-0182280

(51) Int. Cl. B01D 29/23; B01D 15/38; B01D 29/52; B01D 29/58; B01D 39/14; B01D 61/14; B01D 61/18; C02F 1/00; C02F 1/28; C02F 1/44; C02F 1/48; C02F 9/00

(52) U.S. Cl. CPC B01D 29/23; B01D 15/38; B01D 29/52; B01D 29/58; B01D 39/14; B01D 61/145; B01D 61/18; C02F 9/00; B01D 2239/0618; C02F 1/003; C02F 1/283; C02F 1/444; C02F 1/48; C02F 2307/04

(57) ABSTRACT

A water filtration device according to the present invention comprises: a water storage container portion having an open upper side and formed to be concave downward to form a first water storage space therein; a water introduction container portion having an open upper side and formed to be concave downward to form a second water storage space inside, the water introduction container portion being disposed on an upper inner side of the container portion; and a filter portion which is detachably fixed to the water introduction container portion, when water supplied to the second water storage space of the water introduction container portion is introduced therein, filters the water, and then discharges the water into the first water storage space, wherein the filter portion includes a pre-filter including a first filter member in the form of a hollow tube having a hollow formed in the center thereof, and a second filter member disposed in the hollow of the first filter member and made of a material different from that of the first filter member.

### TECHNICAL FIELD

The present invention relates to a simplified water filtration device.

BACKGROUND ART

Due to recent industrial development, water pollution and the resulting shortage of water resources are emerging as serious problems. While the demand for better quality water is rapidly increasing due to the advancement of the industrial structure, the population growth, and the improvement in living standards, water pollution caused by domestic wastewater and industrial wastewater is becoming increasingly serious, and usable water is becoming increasingly scarce. Thus, water purifiers have been developed and are widely used to provide clean water for people to drink.

These water purifiers are devices that purify raw water, such as tap water, into drinking water that complies with Article 5, Paragraph 3 of the Drinking Water Management Act, and are devices that filter water using a water purification filter through physical and chemical processes before supplying the water.

Water purifiers are devices that filter water using a water purification filter through physical and chemical processes before supplying the water. The water purifiers are classified into a natural filtration type in which stored water passes through a ceramic filter by gravity, a direct filtration type, in which a water purifier is directly connected to a faucet, an ion exchange resin type in which metal ions dissolved in water are separated and removed using an ion exchange resin filter, a distillation type in which steam produced when water boils is cooled to purify the water, a reverse osmosis type in which water passes through a semipermeable membrane by a pressure to filter impurities, etc.

That is, the water purifiers may be classified into the following manners based on the purification manner: a natural filtration manner in which stored water passes through a ceramic filter by gravity; a direct filtration manner, in which a water purifier is directly connected to a faucet; an ion exchange resin manner in which metal ions dissolved in water are separated and removed using an ion exchange resin filter; a distillation manner in which steam produced when water boils is cooled to purify the water; a reverse osmosis manner in which water passes through a semipermeable membrane by a pressure to filter impurities, etc.

In the various types of water purifiers described above, the natural filtration manner is a manner in which separate power is not required to be often used for portable in outdoor. As a related art, Korean Patent Publication No. 10-2012-0108410 discloses a technology related to a portable water purifier. Ass another related art, Korean Utility Model No. 20-0429134 discloses a technology related to an alkaline reduced water generator having a natural filtration water purification function. Referring to these related arts, it may be seen that the water purifiers using the natural filtration manner, unlike the direct filtration manner, has a separate built-in tank to store raw water.

### DISCLOSURE OF THE INVENTION

### Technical Problem

A physical filtration is performed in a sediment nonwoven fabric included in a pre-filter of a water filtration device of the present invention.

A particulate material, a rust residue, and a suspended material, each of which has a size of 3 μm to 5 μm or more, may be filtered by the sediment nonwoven fabric. In addition, a problem in which fine dusts leak out even when water flows in a reverse direction may be solved.

In addition, adsorption and filtration are performed in a carbon block included in the pre-filter.

The carbon block may adsorb and remove residual chlorine, volatile organic compounds (VOCs), heavy metals, and particulate materials in water, improve water turbidity and color, and adsorb and remove odor.

In addition, electrostatic adsorption is performed on the electrostatic adsorption material included in the post-filter.

Due to the electrostatic adsorption material, it is possible to adsorb and remove bacteria and viruses in water.

In addition, the physical filtration is performed in a UF membrane included in the post-filter.

The bacteria and particulate material, each of which has a size greater than 0.2 μm in water, may be filtered by the UF membrane.

In addition, ion exchange is performed in an ion exchange resin included in the pre-filter.

Major lime materials such as calcium and magnesium in water may be removed through the ion exchange by the (cation) exchange resin, and a water hardness value may be lowered.

In addition, in the case of the present invention, a problem in which water flows backward in a gravity filtration manner may be solved by using a passage structure in which water is filtered from a hollow the carbon block to the outside.

In addition, at least three filter members may be accommodated in one filter housing to improve filtration capacity, the filter may be miniaturized, and the passage structure may be improved due to a horizontal arrangement of the plurality of filter members, to implement a high flow rate and high performance.

### Technical Solution

A water filtration device according to the present invention includes a water storage container portion having an opened upper side and provided to be concave downward so as to provide a first water storage space therein, a water introduction container portion having an opened upper side and provided to be concave downward so as to provide a second water storage space therein, wherein the water introduction container portion is disposed at an inner upper side of the container portion, and a filter portion detachably fixed to the water introduction container portion, wherein when water supplied to the second water storage space of the water introduction container portion is introduced, the filter portion is configured to filter the water and then discharge the filtered water into the first water storage space.

The filter portion may include a pre-filter comprising a first filter member provided in the form of a hollow tube having a hollow at a central portion thereof and a second filter member disposed in the hollow of the first filter member and made of a material different from that of the first filter member.

The water introduced into the pre-filter may pass through the second filter member and then pass through the first filter member.

The first filter member may be made of a hollow carbon block.

The second filter member may be provided as a sediment nonwoven fabric disposed in the hollow of the first filter member.

The pre-filter may include a first pre-filter disposed at a side, and a second pre-filter disposed to be parallel to and spaced apart from the first pre-filter.

A post-filter having at least one of an electrostatic adsorption material or a UF membrane may be disposed between the first pre-filter and the second pre-filter, wherein the water discharged from the first pre-filter and the second pre-filter may pass through the post-filter and then be discharged into the first water storage space.

The filter portion may further include a first post-filter in which an electrostatic adsorption member is built, wherein the water passing through the pre-filter may pass through the first post-filter and then be discharged into the first water storage space.

The electrostatic adsorption material may be provided in the form of a hollow tube and be wrinkled in a circumferential direction.

The filter portion may further include a second post-filter in which a UF membrane is built, wherein the water passing through the pre-filter may pass through the second post-filter and then be discharged into the first water storage space.

The water introduction container portion may be configured to provide a filter accommodation portion that is concave downward at a lower side of the second water storage space, and a discharge port opened so that the filtered water is discharged into the first water storage space may be provided at a lower end of the filter accommodation portion.

The filter portion may be provided with a filter housing that is fitted into the filter accommodation portion in a vertical direction and then is separated.

The filter housing may be provided with a lower housing disposed at a lower side and provided to be concave downward and an upper housing configured to cover an upper side of the lower housing.

The upper housing may be configured to provide an extension wall extending downward along a circumference thereof, wherein a lower end of the extension wall may be fixed to be fitted into an upper end of the lower housing.

A first stepped portion provided to be concave inward from an outer surface may be disposed along a circumference at the lower end of the extension wall, and a second stepped portion provided to be concave outward from an inner surface may be disposed along a circumference at the upper end of the lower housing, wherein the first stepped portion may be fitted into the second stepped portion.

A grip portion provided to be convex upward may be disposed on an upper end of the upper housing.

An inlet port opened vertically to allow the water in the second water storage space to be introduced into the housing may be disposed in the upper housing.

The inlet port may be connected to the hollow of the first filter member.

An outlet port opened vertically to allow the water within the housing to be discharged downward may be disposed in a lower end of the lower housing.

The water passing through the post-filter may be discharged to the outside of the filter housing through the outlet port.

The water filtration device may be applied to at least one of a simplified water purifier, an under sink water purifier, a natural filtration water purifier, a gravity filtration water purifier, or a jug type water purifier.

### Advantageous Effects

According to the present invention, there may be the effect in which the complex passage structure is improved to simplify the passage structure, thereby increasing in high flow rate, that is, purified water flow rate.

The physical filtration may be performed in the sediment nonwoven fabric included in the pre-filter of the water filtration device of the present invention.

The particulate material, the rust residue, and the suspended material, each of which has the size of 3 μm to 5 μm or more, may be filtered by the sediment nonwoven fabric. In addition, there may be the advantage in that the fine dusts do not leak out even when the water flows in the reverse direction.

In addition, the adsorption and filtration may be performed in the carbon block included in the pre-filter.

There may be the advantage in that the carbon block adsorbs and removes the residual chlorine, volatile organic compounds (VOCs), the heavy metals, and the particulate materials in the water, improve the water turbidity and color, and adsorbs and removes the odor.

In addition, the electrostatic adsorption may be performed on the electrostatic adsorption material included in the post-filter.

There may be the advantage in that, due to the electrostatic adsorption material, it is possible to adsorb and remove the bacteria and viruses in the water.

In addition, the physical filtration may be performed in the UF membrane included in the post-filter.

The bacteria and particulate material, each of which has the size greater than 0.2 μm in water, may be filtered by the UF membrane.

In addition, the ion exchange may be performed in the ion exchange resin included in the pre-filter.

There may be the advantage in that the major lime materials such as calcium and magnesium in the water are removed through the ion exchange by the (cation) exchange resin, and the water hardness value is lowered.

In addition, in the case of the present invention, there may be the advantage in that the water does not flow backward in the gravity filtration manner by using the passage structure in which the water is filtered from the hollow the carbon block to the outside.

In addition, there may be the advantage in that the at least three filter members are accommodated in one filter housing to improve the filtration capacity, the filter is miniaturized, and the passage structure is improved due to the horizontal arrangement of the plurality of filter members, to implement the high flow rate and the high performance.

### BRIEF DESCRIPTION OF THE DRAWINGS

FIG. 1 is a perspective view of a water filtration device according to an embodiment of the present invention.

FIG. 2 is a view illustrating a state in which a lid is separated in FIG. 1.

FIG. 3 is an exploded perspective view of the water filtration device according to an embodiment of the present invention.

FIG. 4 is an exploded perspective view of a filter portion that is a component of the present invention.

FIG. 5 is a partial cutaway perspective view of the water filtration device according to an embodiment of the present invention.

FIG. 6 is a cross-sectional view illustrating a portion on which the filter portion is mounted in the water filtration device according to an embodiment of the present invention.

FIG. 7 is a perspective view illustrating an example of an electrostatic adsorption member that is built in a first post-filter, which is a component of the present invention.

FIG. 8 is a cross-sectional view illustrating an example a second post-filter that is a component of the present invention.

### MODE FOR CARRYING OUT THE INVENTION

Hereinafter, exemplary embodiments will be described in detail with reference to the accompanying drawings. The invention may, however, be embodied in many different forms and should not be construed as being limited to the embodiments set forth herein, and a person of ordinary skill in the art, who understands the spirit of the present invention, may readily implement other embodiments included within the scope of the same concept by adding, changing, deleting, and adding components; rather, it will be understood that they are also included within the scope of the present invention.

The drawings attached to the following embodiments are embodiments of the scope of the invention, but to facilitate understanding within the scope of the present invention, in the description of the fine portions, the drawings may be expressed differently according to the drawings, and the specific portions may not be displayed according to the drawings, or may be exaggerated according to the drawings.

In the following descriptions, a water filtration device of the present invention is described as a simplified water purifier, as an example. However, the water filtration device of the present invention may mean at least one of a simplified water purifier, an under sink water purifier, a natural filtration water purifier, a gravity filtration water purifier, and a jug type water purifier.

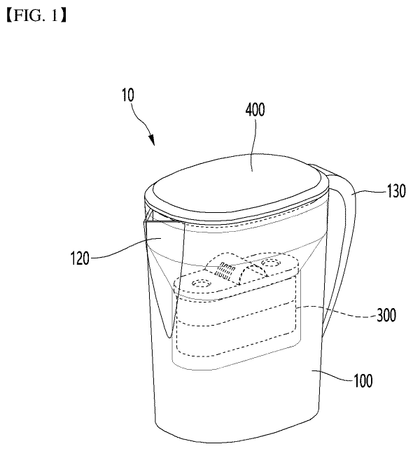

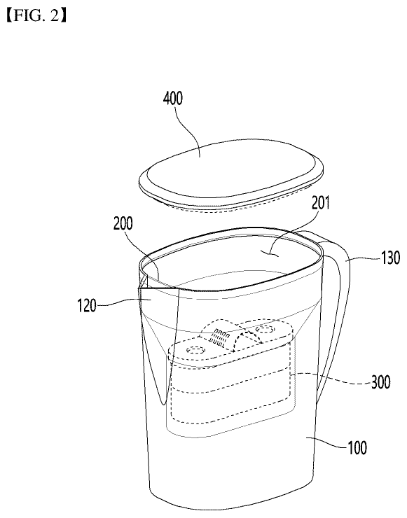

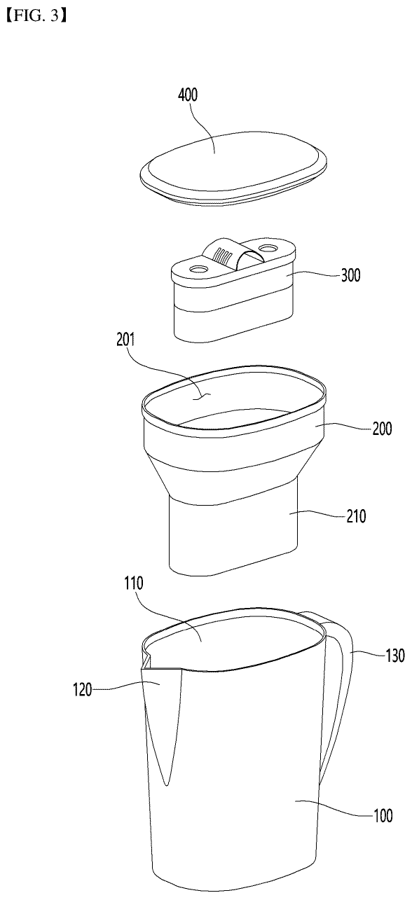

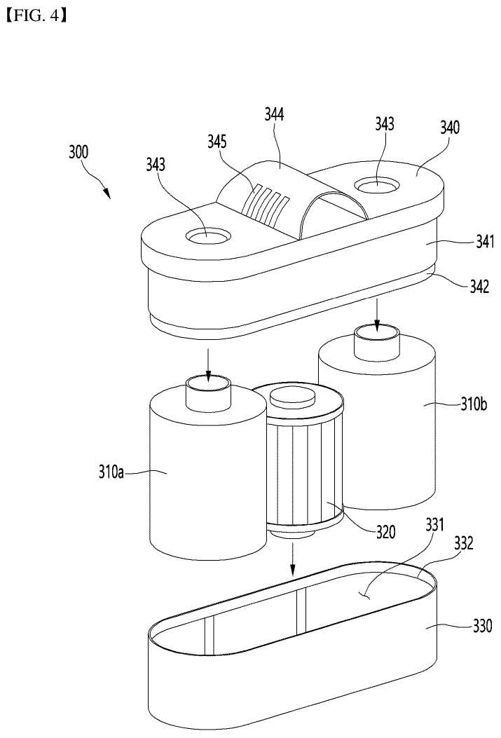

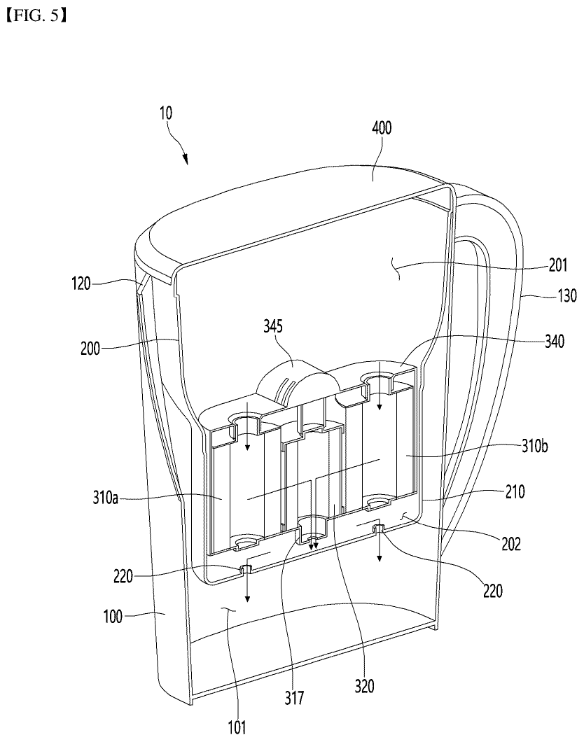

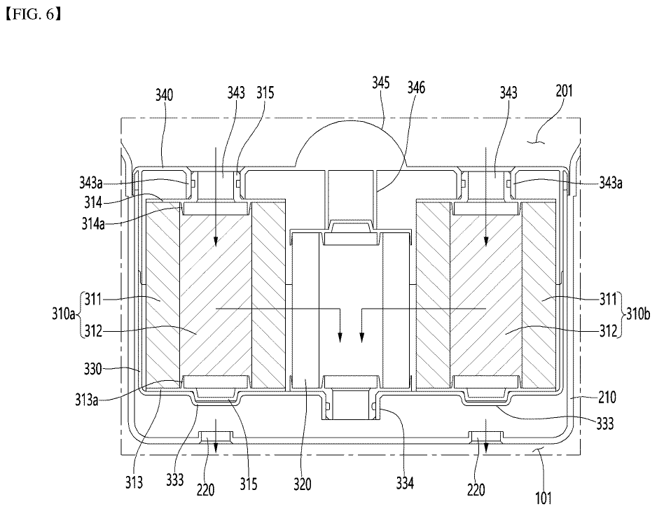

FIG. 1 is a perspective view of a water filtration device according to an embodiment of the present invention. In addition, FIG. 2 is a view illustrating a state in which a lid is separated in FIG. 1. In addition, FIG. 3 is an exploded perspective view of the water filtration device according to an embodiment of the present invention. In addition, FIG. 4 is an exploded perspective view of a filter portion that is a component of the present invention. In addition, FIG. 5 is a partial cutaway perspective view of the water filtration device according to an embodiment of the present invention. In addition, FIG. 6 is a cross-sectional view illustrating a portion on which the filter portion is mounted in the water filtration device according to an embodiment of the present invention.

In general, in the case of the simplified water purifier using a gravity filtration manner, activated carbon is generally used to secure minimum removal performance and flow rate, but the present invention has a multi-filter structure constituted by at least one pre-filter and at least one post-filter and is configured as a passage structure optimized for the gravity filtration manner.

The pre-filter may be provided with a carbon block manufactured by mixing granular activated carbon with powdered activated carbon to secure a stability and sufficient flow rate for pollutant removal performance, and the post-filter may apply an electrostatic adsorption (positive charge) material to minimize generation of fine dusts and remove bacteria and viruses.

Referring to FIGS. 1 to 6, a water filtration device according to the present invention includes a water storage container portion 100 that has an opened upper side to define a first opening 110 and is provided to be concave downward to define a first water storage space 101 therein.

Purified water passing through a filter portion 300 is stored in the first water storage space 101.

In addition, the water storage container portion 100 may have a jug shape.

The water storage container portion 100 may have a handle 130 disposed on one side surface to protrude outward, and a water discharge groove 120 defined to be pointed outward may be defined at an opposite side of the handle 130 so that water in the first water storage space 101 is collected to flow when the handle 130 is held to tilt the water storage container portion 100.

In addition, the water filtration device includes a water introduction container portion 200 having an opened upper side to define a second opening 201, provided to be concave downward to define a second water storage space 201 therein, and disposed on an inner upper portion of the water introduction container portion 100.

In addition, the water filtration device includes the filter portion 300 that is detachably fixed to the water introduction container portion 200 and filters water when the water supplied to the second water storage space 201 of the water introduction container portion 200 is introduced to discharge the water into the first water storage space 101.

The water introduction container portion 200 receives raw water and supplies the raw water to the filter portion 300.

In addition, the filter portion 300 includes pre-filters 310a and 310b including a first filter member 311 provided in the form of a hollow tube having a hollow defined at a central portion thereof, and a second filter member 312 disposed on an inner or outer circumferential surface of the first filter member 311 and made of a material different from that of the first filter member 311.

Thus, the water supplied to the second water storage space 201 of the water introduction container portion 200 first passes through the second filter member 312 and then passes through the first filter member 311 so as to be filtered and then is discharged and stored in the first water storage space 101.

As another example, the water supplied to the second water storage space 201 of the water introduction container portion 200 first passes through the first filter member 311 and then passes through the second filter member 312 so as to be filtered and then is discharged and stored in the first water storage space 101.

The second filter member 312 may be provided with a sediment nonwoven fabric disposed in the hollow of the first filter member 311.

In addition, the sediment nonwoven fabric may be disposed on an outer circumferential surface as well as an inner circumferential surface of the carbon block.

As described above, when the sediment nonwoven fabric is provided, even if water flows backward, a problem in which fine dusts leak to the second water storage space 201 while filtering fine dusts in water may be prevented from occurring.

In addition, when the sediment nonwoven fabric is provided as described above, the problem in which the fine dusts leak to purified water while filtering the fine dusts in the water may be improved.

As another example, the second filter member 312 may be provided with an ion exchange resin disposed in the hollow of the first filter member 311.

When the ion exchange resin is provided as described above, hardness materials in water may be removed as calcium, magnesium, etc., are ion-exchanged.

The pre-filters 310a and 310b may be provided as one filter.

The pre-filters 310a and 310b may be provided in plurality and be disposed in series or parallel.

The pre-filters 310a and 310b may include a first pre-filter 310a disposed at one side and a second pre-filter 310b disposed to be parallel to and spaced apart from the first pre-filter 310a.

A post-filter 320 having an electrostatic adsorption material or a UF membrane, which is built therein, is disposed between the first pre-filter 310a and the second pre-filter 310b, and water discharged from the first pre-filter 310a and the second pre-filter 310b passes through the post-filter 320 and then is discharged to the first water storage space 101.

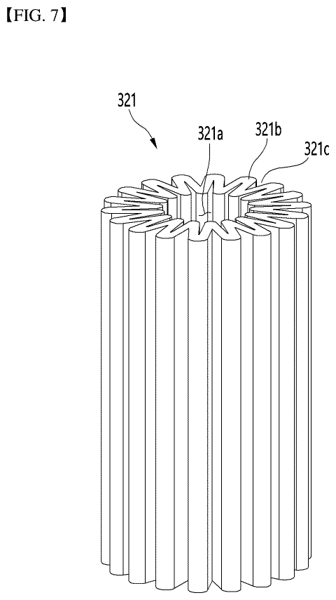

FIG. 7 is a perspective view illustrating an example of an electrostatic adsorption member that is built in the first post-filter, which is a component of the present invention.

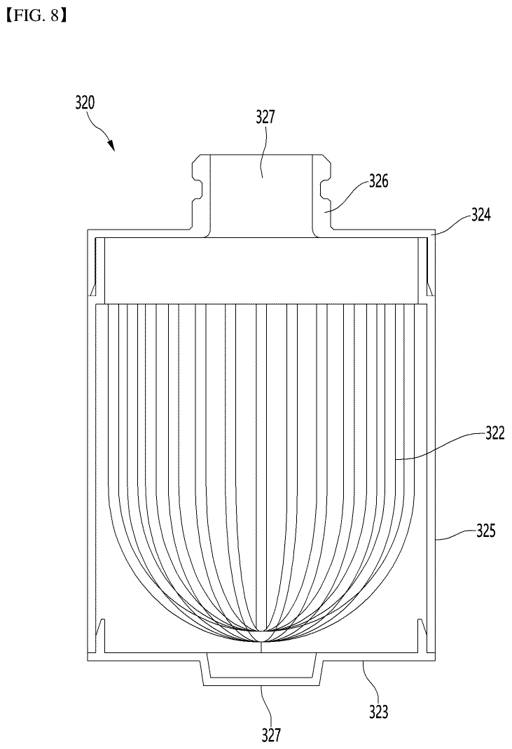

FIG. 8 is a cross-sectional view illustrating an example the second post-filter that is a component of the present invention.

Referring to FIG. 7, an electrostatic adsorption member 321 is built in the post-filter 320.

In addition, water passing through the pre-filter 310a and 310b may pass through the electrostatic adsorption member 321 inside the post-filter 320 and then be discharged to the first water storage space 101.

The electrostatic adsorption member 321 may be provided with an electrostatic adsorption nonwoven fabric.

The electrostatic adsorption member 321 may be made of a positive charge material and may adsorb negative charges in water.

The electrostatic adsorption member 321 may include activated carbon.

The electrostatic adsorption member 321 may adsorb and remove viruses, bacteria, etc., in water.

The electrostatic adsorption material 321 may have a hollow tube shape and may be wrinkled in a circumferential direction.

The electrostatic adsorption material 321 may define a hollow 321 and may include a convex portion 321b that is convex outward and a concave portion 321c that is concave inward.

As described above, when the electrostatic adsorption material 321 is wrinkled, a surface area of the electrostatic adsorption material 321 may increase, and viruses, bacteria, etc., in water passing through the electrostatic adsorption material 321 may be removed more reliably.

In addition, the electrostatic adsorption nonwoven fabric may provide a closed curve by wrinkle-processing the rectangular nonwoven fabric and thermally fusing the nonwoven fabric in a state in which both ends thereof are in contact with each other.

Here, the thermally fused portion may be provided on the electrostatic adsorption nonwoven fabric by thermally fusing both the ends of the electrostatic adsorption nonwoven fabric.

In addition, an outer circumference of the electrostatic adsorption nonwoven fabric may further include a second electrostatic adsorption nonwoven fabric provided to be wrapped.

In the present invention, a case in which the wrinkles are formed on the electrostatic adsorption nonwoven fabric is described as an example, but the scope of the present invention is not limited thereto, and the electrostatic adsorption nonwoven fabric may not have the wrinkles.

In addition, the electrostatic adsorption nonwoven fabric may have a roll shape.

In addition, the electrostatic adsorption nonwoven fabric may be provided in a single layer.

In addition, the electrostatic adsorption nonwoven fabric may be provided in multiple layers.

In addition, when the electrostatic adsorption nonwoven fabric is provided in the multiple layers, heavy metals in water may be removed more reliably.

For example, the electrostatic adsorption nonwoven fabric may be provided as an anion electrostatic adsorption nonwoven fabric.

As another example, the electrostatic adsorption nonwoven fabric may be provided as a cationic electrostatic adsorption nonwoven fabric.

Referring to FIG. 8, a UF membrane 322 may be built in the post-filter 320, and the water passing through the pre-filter 310a and 310b may pass through the UF membrane 322 inside the post-filter 320 and then be discharged into the first water storage space 101.

In addition, the water introduction container portion 200 may provide a filter accommodation portion 210 that is concave downward at a lower portion of the second water storage space 201, and a discharge port 220 that is opened so that the filtered water is discharged to the first water storage space 101 may be provided at a lower end of the filter accommodation portion 210.

In the filter accommodation portion 210, a filter accommodation space 202 communicating with the second water storage space 201 is defined.

The filter accommodation space 202 may be defined smaller than the second water storage space 201.

In addition, the filter portion 300 may be provided with filter housings 330 and 340 that are inserted vertically into the filter accommodation portion 210 and then are separated.

The filter housings 330 and 340 may be provided with a lower housing 330 that is disposed at a lower side and is provided to be concave downward to define a space portion 331, and an upper housing 340 that covers an upper side of the lower housing 330.

In addition, the upper housing 340 may provide an extension wall 341 extending downward along a circumference, and a lower end of the extension wall 341 may be fitted into and fixed to an upper end of the lower housing 330.

In addition, the upper housing 340 may provide the extension wall 341 extending downward along the circumference, and the upper end of the lower housing 330 may be fitted and fixed to a lower end of the extension wall 341.

In addition, a first stepped portion 342 provided to be concave inward from an outer surface may be disposed along the circumference at the lower end of the extension wall 341, and a second stepped portion 332 provided to be concave inward from an inner surface may be disposed along the circumference at the upper end of the lower housing 330. The first stepped portion 342 may be fitted into and fixed to the second stepped portion 332.

In addition, a grip portion 345 that is provided to be convex upward may be disposed on the upper end of the upper housing 340.

Thus, the user may hold the grip portion 345 to separate the filter portion 300 from the filter accommodation portion 210 of the water introduction container portion 200.

In addition, the user may hold the grip portion 345 to insert the filter portion 300 into the filter accommodation portion 210 of the water introduction container portion 200.

In addition, an inlet port 343 that is opened vertically to allow water in the second water storage space 201 to be introduced into the housings 330 and 340 may be provided in the upper housing 340.

The inlet port 343 may be connected to the hollow of the first filter member 311 so that the water introduced into the inlet port 343 is introduced into only the hollow of the first filter member 311.

For example, the pre-filters 310a and 310b may be provided in two and disposed at both sides of the post-filter 320, respectively. Here, the inlet port 343 may be provided at both sides of the upper housing 340 corresponding to the hollow of the first filter member 311 of each of the pre-filters 310a and 310b.

The pre-filters 310a and 310b are provided with an upper cover 314 disposed above the first filter member 311 and a lower cover 313 disposed below the first filter member 311.

In addition, the lower cover 313 defines an insertion portion 315 protruding downward at a central portion thereof.

In addition, the lower housing 330 may define an insertion groove 333 in a bottom surface so that the insertion portion 315 is inserted.

Thus, since the insertion portion315 is fitted into the insertion groove 333, the lower cover 313 may be fixed to the lower housing 330.

In addition, the upper cover 314 provides an inflow tube 316 extending upward at a central portion thereof. In addition, the inflow tube 316 is inserted into the inlet port 343.

Thus, water introduced into the inlet port 343 may flow to the inflow tube 316 and then flow to the hollow of the first filter member 311 that communicates with the inflow tube 316.

In addition, an outlet port 334 that is opened vertically to allow water within the housing 330 to be discharged downward is provided in the lower end of the lower housing 330.

In addition, the water passing through the post-filter 320 is discharged to the outside of the filter housings 330 and 340 through the outlet port 334.

The post-filter 320 includes post-filter housings 323, 324, and 325.

The post-filter housings 323, 324, and 325 includes a first housing 323 disposed at an upper side, a second housing 324 disposed at a lower side, and a third housing 325 defining a side surface on the basis of a state of being mounted on the filter housings 330 and 340.

The third housing 325 may have at least one opened communication hole that allows water to be introduced from the outside to the inside.

According to the situation, the third housing 325 may be omitted.

In addition, a discharge tube 326 extending downward may be provided at a central portion of the second housing 324, and a discharge port 327 may be provided inside the discharge tube 326, and the water inside the post-filter housings 323, 324, and 325 may be discharged to the outside through the discharge port 327.

The discharge tube 326 may be inserted into the outlet port 334.

Thus, the water discharged through the discharge tube 326 may be discharged directly to the outside of the filter housings 330 and 340 through the outlet port 334.

In addition, the water discharged through the outlet port 334 may be discharged to the first water storage space 101 through the discharge port 220 provided in the lower end of the filter accommodation portion 210.

In addition, the upper housing 340 may provide a pressing portion 346 extending downward at the central portion, and a lower end of the pressing portion 346 may press and fix the upper end of the first housing 323.

In addition, the pressing portion 346 may have a hollow, and the first housing 323 may provide a protrusion protruding upward at the central portion. When the pressing portion 346 presses the upper end of the first housing 323, the protrusion may be fitted into a lower end of the pressing portion 346.

According to the structure as described above, when water is supplied to the second water storage space 201, the water is introduced through the inlet port 343 and then introduced into the hollow of the first filter member 311 through the inflow tube 316 connected to the inlet port 343.

In addition, the water passing horizontally through the second filter member 312 and the first filter member 311 flows horizontally again and then is introduced into the post-filter 320.

In addition, the water passing through the post-filter 320 is discharged through the discharge tube 326 and then is discharged to the outside of the filter housings 330 and 340 through the outlet port 334 connected to the discharge tube 326.

Thereafter, the water is discharged to the lower side of the filter accommodation portion 210 through the discharge port 220 and then is stored in first water storage space 101 as purified water.

The present invention may horizontally arrange the electrostatic adsorption nonwoven fabric, the carbon block, and the UF membrane in a single filter housing to simultaneous adsorb and remove bacteria and viruses that may exist in tap water. In addition, the UF membrane may be disposed inside the carbon block so that the water passing through the electrostatic adsorption nonwoven fabric and the carbon block passes through the UF membrane with the physical filtration function that is in a size exclusion manner to reliably removing carbon particles and particulate material.

In addition, this transverse arrangement structure is more advantageous for high-flow, high-performance implementation for the following reasons.

First, the water introduced from the upper side to the lower side after being introduced into the filter housings 330 and 340 may move laterally to pass through the electrostatic adsorption nonwoven fabric, the carbon block, and the UF membrane in sequence. In addition, the water flows downward and then is discharged from the filter housings 330 and 340.

That is, in the case of the present invention, the water introduced from the upper side to the lower side flows laterally and then flows from the upper side to the lower side.

Therefore, the passage structure through which the water flows may be simplified, and a flow rate reduction phenomenon that occurs in complex passage structures may be improved.

In addition, a volume of the electrostatic adsorption non-woven fabric, the carbon block, and the UF membrane may increase to improve filtration power.

That is, according to the present invention, the higher flow rate and higher performance may be implemented in the filter having the same size.

The main features of the present invention are the configuration of the filter and the passage structure. The configuration of the filter is a configuration in which the two pre-filters 310a and 310b provided with the sediment nonwoven fabric and the carbon block are disposed in parallel at both sides, and the water passing through the pre-filter passes through the post-filter 320 provided with the electrostatic adsorption material and then is finally discharged.

In the passage structure, the raw water is introduced through the inlet ports 343 disposed at both the sides provided at the upper ends of the filter housings 330 and 340, introduced into the hollows of the two carbon blocks 311, passes through the inner sediment nonwoven fabric, and then passes through the carbon blocks. Alternatively, the raw water is introduced through the inlet ports 343 disposed at both the sides provided at the upper ends of the filter housings 330 and 340, introduced into the hollows of the two carbon blocks 311, passes through the carbon blocks, and then passes through the outer sediment nonwoven fabric.

Thereafter, the water flows from the outside to the inside of the post-filter 320 disposed at the central portion, passes through the UF membrane or the electrostatic adsorption nonwoven fabric, and then flows downward.

Thereafter, the water is discharged to the lower side of the filter housings 330 and 340 through the outlet port 334.

According to the present invention, the carbon block may be applied to the pre-filter to remove major pollutants such as residual chlorine, volatile organic compounds (VOCs), heavy metals, particulate material, and turbidity.

In addition, the sediment nonwoven fabric may be applied to the inside or outside of the carbon block to prevent fine dusts from leaking, which may occur in the carbon block.

In addition, the plurality of filters are disposed in parallel to ensure sufficient water purification performance and water flow rate.

In addition, to enhance hygiene of the simplified water purifier, the electrostatic adsorption material, in which the activated carbon capable of removing bacteria and viruses is impregnated, is applied to the post-filter 320.

In addition, the post-filter 320 may be provided with a UF membrane having the physical filtration function through pores instead of the electrostatic adsorption material.

Therefore, the simplified water purifier according to the present invention may be used not only at home but also during outdoor activities such as camping and fishing.

In addition, as a modified example, a hardness removal function may be added by filling an (anion) ion exchange resin inside the carbon block when configuring the filter.

Another important feature of the present invention is the passage structure in which the raw water is introduced into the hollow carbon block and is filtered as the water flows to the outside of the carbon block.

In addition, due to the simplified water purifier, in which water is filtered by the natural pressure, the passage structure may be designed as simply as possible to solve the problem of the backflow in the gravity filtration manner.

In addition, the passage, in which water flows from the inside to the outside of the carbon block and flows from the outside to the inside of the post filter, and then is finally discharged may be implemented so that the water naturally flows in the forward direction.

The physical filtration is performed in the sediment nonwoven fabric included in the pre-filter.

The particulate material, the rust residue, and the suspended material, each of which has the size of 3 μm to 5 μm or more, may be filtered by the sediment nonwoven fabric. In addition, a problem in which fine dusts leak out even when water flows in a reverse direction may be solved.

In addition, the adsorption and filtration may be performed in the carbon block included in the pre-filter.

The carbon block may adsorb and remove residual chlorine, volatile organic compounds (VOCs), heavy metals, and particulate materials in water, improve water turbidity and color, and adsorb and remove odor.

In addition, the electrostatic adsorption may be performed on the electrostatic adsorption material included in the post-filter.

Due to the electrostatic adsorption material, it is possible to adsorb and remove bacteria and viruses in water.

In addition, the physical filtration may be performed in the UF membrane included in the post-filter.

The bacteria and particulate material, each of which has the size greater than 0.2 μm in water, may be filtered by the UF membrane.

In addition, the ion exchange may be performed in the ion exchange resin included in the pre-filter.

Major lime materials such as calcium and magnesium in water may be removed through the ion exchange by the (cation) exchange resin, and a water hardness value may be lowered.

In addition, in the case of the present invention, a problem in which water flows backward in a gravity filtration manner may be solved by using a passage structure in which water is filtered from a hollow the carbon block to the outside.

In addition, there may be the advantage in that the at least three filter members are accommodated in one filter housing to improve the filtration capacity, the filter is miniaturized, and the passage structure is improved due to the horizontal arrangement of the plurality of filter members, to implement the high flow rate and the high performance.

1. A water filtration device comprising:
a water storage container portion having an opened upper side and provided to be concave downward so as to provide a first water storage space therein;
a water introduction container portion having an opened upper side and provided to be concave downward so as to provide a second water storage space therein, wherein the water introduction container portion is disposed at an inner upper side of the container portion; and
a filter portion detachably fixed to the water introduction container portion, wherein when water supplied to the second water storage space of the water introduction container portion is introduced, the filter portion is configured to filter the water and then discharge the filtered water into the first water storage space,
wherein the filter portion comprises a pre-filter comprising a first filter member provided in the form of a hollow tube having a hollow at a central portion thereof and a second filter member disposed in the hollow of the first filter member and made of a material different from that of the first filter member.

2. The water filtration device according to claim 1, wherein the water introduced into the pre-filter passes through the second filter member and then passes through the first filter member.

3. The water filtration device according to claim 1, wherein the first filter member is made of a hollow carbon block.

4. The water filtration device according to claim 3, wherein the second filter member is provided as a sediment nonwoven fabric disposed in the hollow of the first filter member.

5. The water filtration device according to claim 1, wherein the pre-filter comprises:
a first pre-filter disposed at a side; and
a second pre-filter disposed to be parallel to and spaced apart from the first pre-filter.

6. The water filtration device according to claim 5, wherein a post-filter having at least one of an electrostatic adsorption material or a UF membrane is disposed between the first pre-filter and the second pre-filter,
wherein the water discharged from the first pre-filter and the second pre-filter passes through the post-filter and then is discharged into the first water storage space.

7. The water filtration device according to claim 1, wherein the filter portion further comprises a first post-filter in which an electrostatic adsorption member is built,
wherein the water passing through the pre-filter passes through the first post-filter and then is discharged into the first water storage space.

8. The water filtration device according to claim 7, wherein the electrostatic adsorption material is provided in the form of a hollow tube and is wrinkled in a circumferential direction.

9. The water filtration device according to claim 1, wherein the filter portion further comprises a second post-filter in which a UF membrane is built,
wherein the water passing through the pre-filter passes through the second post-filter and then is discharged into the first water storage space.

10. The water filtration device according to claim 1, wherein the water introduction container portion is configured to provide a filter accommodation portion that is concave downward at a lower side of the second water storage space, and
a discharge port opened so that the filtered water is discharged into the first water storage space is provided at a lower end of the filter accommodation portion.

11. The water filtration device according to claim 10, wherein the filter portion is provided with a filter housing that is fitted into the filter accommodation portion in a vertical direction and then is separated.

12. The water filtration device according to claim 11, wherein the filter housing is provided with:
a lower housing disposed at a lower side and provided to be concave downward; and
an upper housing configured to cover an upper side of the lower housing.

13. The water filtration device according to claim 12, wherein the upper housing is configured to provide an extension wall extending downward along a circumference thereof,
wherein a lower end of the extension wall is fixed to be fitted into an upper end of the lower housing.

14. The water filtration device according to claim 13, wherein a first stepped portion provided to be concave inward from an outer surface is disposed along a circumference at the lower end of the extension wall, and
a second stepped portion provided to be concave outward from an inner surface is disposed along a circumference at the upper end of the lower housing,
wherein the first stepped portion is fitted into the second stepped portion.

15. The water filtration device according to claim 12, wherein a grip portion provided to be convex upward is disposed on an upper end of the upper housing.

16. The water filtration device according to claim 12, wherein an inlet port opened vertically to allow the water in the second water storage space to be introduced into the housing is disposed in the upper housing.

17. The water filtration device according to claim 16, wherein the inlet port is connected to the hollow of the first filter member.

18. The water filtration device according to claim 16, wherein an outlet port opened vertically to allow the water within the housing to be discharged downward is disposed in a lower end of the lower housing.

19. The water filtration device according to claim 18, wherein the water passing through the post-filter is discharged to the outside of the filter housing through the outlet port.

20. The water filtration device according to claim 1, wherein the water filtration device is applied to at least one of a simplified water purifier, an under sink water purifier, a natural filtration water purifier, a gravity filtration water purifier, or a jug type water purifier.
